(19) United States
(12) Patent Application Publication
(10) Pub. No.: US 2025/0104945 A1
(43) Pub. Date: Mar. 27, 2025

(54) Method for detecting breakdown vacuum level of composite breakdown path

(71) Applicant: XI'AN JIAOTONG UNIVERSITY, Xi'an (CN)

(72) Inventors: Hui Ma, Xi'an (CN); Yulong Gao, Xi'an (CN); Yirui Zhang, Xi'an (CN); Zhiyuan Liu, Xi'an (CN); Yingsan Geng, Xi'an (CN); Jianhua Wang, Xi'an (CN)

(21) Appl. No.: 18/975,626

(22) Filed: Dec. 10, 2024

(30) Foreign Application Priority Data
Feb. 27, 2024 (CN) 202410216316.8

(51) Int. Cl. H01H 33/668; H01H 33/662

(52) U.S. Cl. CPC H01H 33/668; H01H 33/662

(57) ABSTRACT

A method for detecting breakdown vacuum level of a composite breakdown path includes steps of: based on a fact that different electrode shapes provide different electric field strengths, designing the composite breakdown path according to breakdown voltage characteristic differences of different breakdown paths; and based on breakdown results of different electrode structures in the different breakdown paths, performing vacuum interrupter vacuum level measurement and calibration. Based on the fact that there are large differences in the breakdown voltages of different electrode gaps under different vacuum conditions, the method can improve the vacuum level detection accuracy of high-voltage vacuum interrupter through the measurement and judgment of breakdown voltages between multiple different electrodes, and can complete the breakdown judgment under the insulating gas environment with high vacuum level or complete leakage, thereby promoting the development of vacuum level detection method for high-voltage vacuum interrupter.

### CROSS REFERENCE OF RELATED APPLICATION

The present invention claims priority under 35 U.S.C. 119 (a-d) to CN 202410216316.8, filed Feb. 27, 2024.

### BACKGROUND OF THE PRESENT INVENTION

### Field of Invention

The present invention relates to a technical field of vacuum level on-line detection for vacuum interrupters, and more particularly to a method for detecting breakdown vacuum level of a composite breakdown path.

### Description of Related Arts

Vacuum circuit breakers are now regarded as a powerful alternative to conventional SF₆ circuit breakers due to excellent breaking capacity and eco-friendly features. Vacuum circuit breakers are now capable of up to 126 kV, but in the application and promotion of vacuum circuit breakers at high voltage level, they are facing the technical problem of vacuum level on-line detection for vacuum interrupters.

After working for a period of time, the vacuum level in the vacuum interrupter will gradually decrease, and there shows no obvious phenomenon that makes the situation unpredictable. If the pressure inside the vacuum interrupter crosses a certain threshold, the vacuum circuit breaker can no longer be reliable or even lose the breaking capacity, causing great harm to the safe operation of the power system. Therefore, it is necessary to perform vacuum level on-line detection for the vacuum circuit breaker. Conventionally, the vacuum level detection for vacuum interrupters in operation is off-line, leading to instability of the power system. Most of the detection equipment is large and heavy, which is difficult to transport to the scene. Furthermore, most of the conventional vacuum interrupter on-line detection technologies have certain defects and deficiencies, and so far are not applied in large-scale. Solving the problem of vacuum level on-line detection for vacuum interrupters will be an important driving force to promote vacuum circuit breakers to higher voltage levels and wider market acceptance.

### SUMMARY OF THE PRESENT INVENTION

In order to solve the above problems, an object of the present invention is to provide a method for detecting breakdown vacuum level of a composite breakdown path. Based on the characteristics that different electrode shapes provide different electric field strengths, a composite breakdown path is designed. According to breakdown results of different electrode structures and different metal gaps in different breakdown paths under the same voltage conditions as well as the same vacuum and air pressure conditions, current vacuum level can be obtained, which realizes the vacuum level measurement and calibration, thereby improving the accuracy of vacuum level detection.

Accordingly, in order to accomplish the above object, the present invention provides:
a method for detecting breakdown vacuum level of a composite breakdown path, comprising steps of: based on a fact that different electrode shapes provide different electric field strengths, designing the composite breakdown path according to breakdown voltage characteristic differences of different breakdown paths; and based on breakdown results of different electrode structures in the different breakdown paths, performing vacuum interrupter vacuum level measurement and calibration;
wherein the method comprises specific steps of:
step 1: performing a single vacuum interrupter vacuum level detection, and setting up multiple independent composite breakdown path vacuum level detection electrode structures in a vacuum interrupter, wherein standard pulse voltages are independently applied on a I-type electrode set, a II-type electrode set and a III-type electrode set using independent breakdown measurement circuits; the three sets of electrodes adopts different gaps and independently applied voltages to avoid breakdown interference; the voltages applied to the three sets of electrodes are U_{A}, U_{B} and U_{C}, which are equal or different;
wherein the three sets of electrodes are located under a vacuum environment inside the vacuum interrupter;
step 2: obtaining breakdown conditions of the composite breakdown path vacuum level detection electrode structures by monitoring breakdown currents through the breakdown measurement circuits, and judging simultaneously whether breakdown occurs in the I-type electrode set, the II-type electrode set or the III-type electrode set; wherein if a breakdown current I_{bA} obtained by a breakdown measurement circuit of the I-type electrode set is greater than a preset breakdown current I_{b1} thereof, then the I-type electrode set is broken down:

$${I}_{bA} > {I}_{b 1} \qquad ( 1 )$$

otherwise, the I-type electrode set is unbroken;
wherein if a breakdown current I_{bB} obtained by a breakdown measurement circuit of the II-type electrode set is greater than a preset breakdown current I_{b2} thereof, then the II-type electrode set is broken down:

$${I}_{bB} > {I}_{b 2} \qquad ( 2 )$$

otherwise, the II-type electrode set is unbroken;
wherein if a breakdown current I_{bC} obtained by a breakdown measurement circuit of the III-type electrode set is greater than a preset breakdown current I_{b3} thereof, then the III-type electrode set is broken down:

$${I}_{bC} > {I}_{b 3} \qquad ( 3 )$$

otherwise, the III-type electrode set is unbroken;
step 3: based on experimentally calibrated breakdown vacuum range of the three sets of electrodes under the different gaps, determining a current vacuum interrupter leakage situation and a leakage coefficient α according to the breakdown results of different electrode structure gaps under the different breakdown paths; to facilitate standard unification, taking an eigenvalue of a current determined vacuum range as a current leakage rate and the leakage coefficient;
wherein if no breakdown occurs after applying the voltages U_{A}, U_{B} and U_{C} to the I-type electrode set, the II-type electrode set or the III-type electrode set, a vacuum level of the vacuum interrupter is normal and the leakage coefficient α=0;
wherein if only the II-type electrode set is broken down, the vacuum interrupter suffers a 20% leakage and the leakage coefficient α=0.2;
wherein if both the I-type electrode set and the II-type electrode set are broken down and the III-type electrode set is unbroken, the vacuum interrupter suffers a 30% leakage and the leakage coefficient α=0.3;
wherein if all the three sets of electrodes are broken down, the vacuum interrupter suffers a 60% leakage and the leakage coefficient α=0.6;
wherein if both the I-type electrode set and the III-type electrode set are broken down and the II-type electrode set is unbroken, the vacuum interrupter suffers a 80% leakage and the leakage coefficient α=0.8;
wherein if only the III-type electrode set is broken down, the vacuum interrupter suffers a complete leakage and the leakage coefficient α=1; and
step 4: according to the breakdown results of the different electrode structures and the different gaps in the different breakdown paths under the different voltages and same vacuum and air pressure conditions, obtaining the current vacuum interrupter leakage coefficient, and then calculating a current vacuum interrupter vacuum level P with an equation (4):

$$P = α {P}_{atm} + ( 1 - α ) {P}_{0} \qquad ( 4 )$$

wherein P₀ is a factory vacuum level of the vacuum interrupter, and Pₐₜₘ is atmospheric pressure;
based on a combination of composite breakdown path breakdown situations, completing vacuum level detection, thereby finishing the single vacuum level detection.

Preferably, a device for performing the method comprises a pulse voltage source, a charge/discharge switch set, the composite breakdown path vacuum level detection electrode structure, a breakdown current measurement module, a control module, and a host computer; wherein through the separate actions of the charge/discharge switch set, the independent voltages are applied on the I-type electrode set, the II-type electrode set and the III-type electrode set; the breakdown current measurement module is independent, and measurement results are returned to the control module each time; the control module communicates with the host computer, and the host computer sends commands to the control module so as to control a next pulse of the pulse voltage source or a switching action of the charge/discharge switch set.

Preferably, the I-type electrode set, the II-type electrode set and the III-type electrode set are rod electrode set, needle electrode set and ball electrode set, respectively; or composite ring electrode sets and plate electrode sets with obvious breakdown differences.

Preferably, the needle electrode set comprises a needle electrode (102) and a needle electrode collection electrode (101); wherein the needle electrode collection electrode (101) is overall spoon-shaped, and a handle portion thereof is parallel to the needle electrode (102) and a spoon portion wraps an end portion of the needle electrode (102), so as to ensure an electron collecting effect; the ball electrode set comprises a ball electrode (104) and a ball electrode collection electrode (103); wherein the ball electrode collection electrode (103) is overall spoon-shaped, and a handle portion thereof is parallel to the ball electrode (104) and a spoon portion wraps an end portion of the ball electrode (104), so as to ensure the electron collecting effect; the rod electrode set comprises a rod electrode (106) and a rod electrode collection electrode (105); wherein the rod electrode collection electrode (105) is overall spoon-shaped, and a handle portion thereof is parallel to the rod electrode (106) and a spoon portion wraps an end portion of the rod electrode (106), so as to ensure the electron collecting effect.

Preferably, materials of the rod electrode set, the needle electrode set and the ball electrode set are selected from a group consisting of Cu, CuCr, Fe, W and Al.

Preferably, the standard pulse voltages are high-frequency pulse voltages.

Preferably, the method for detecting the breakdown vacuum level of the composite breakdown path is periodically performed single vacuum level detection. Since composite electrode breakdown will produce a very small amount of metal vapor, it is not suitable for performing multiple detections in a short period of time. It is necessary to wait for metal vapors to be deposited on a collection hood before detecting again; and an interval period is assigned by days, weeks or months.

Preferably, the multiple independent composite breakdown path vacuum level detection electrode structures are mounted on a static end cover plate or a movable end cover plate of the vacuum interrupter.

Compared with the prior art, the present invention has the following advantages:

The present invention provides the method for detecting the breakdown vacuum level of the composite breakdown path, which is based on the fact that there is a large difference in electrode gap breakdown voltages under high vacuum, low vacuum, low gas pressure, and high gas pressure conditions, as well as that the breakdown voltages are also affected by the electric field strength and the gaps, so as to determine whether the breakdown results of different electrode gaps are different under the same voltage conditions as well as the same vacuum and air pressure conditions. According to breakdown results of different electrode structures and different metal gaps in different breakdown paths, corresponding vacuum or gas pressure ranges can be obtained, which realizes the vacuum level detection in high-voltage vacuum interrupters based on the design of the composite breakdown path, thus improving the vacuum detection accuracy.

### BRIEF DESCRIPTION OF THE DRAWINGS

FIG. 1 is a set of calibration curves for a composite breakdown path breakdown electrode structure of the present invention;

FIG. 2 (a) is a front view of a composite breakdown path vacuum level detection electrode structure;

FIG. 2 (b) is a perspective view of the composite breakdown path vacuum level detection electrode structure;

FIG. 3 is a schematic diagram of an experimental circuit of a method for detecting breakdown vacuum level of a composite breakdown path according to the present invention; and

FIG. 4 is a flowchart of the method for detecting the breakdown vacuum level of the composite breakdown path.

### DETAILED DESCRIPTION OF THE PREFERRED EMBODIMENT

Referring to the drawings and preferred embodiment, the present invention will be further illustrated.

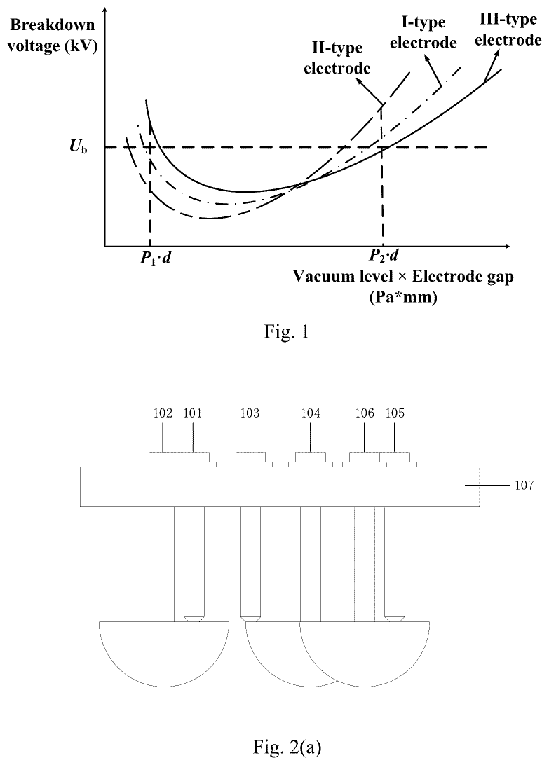

Referring to FIG. 1, a composite breakdown path electrode structure of the present invention comprises a I-type electrode set, a II-type electrode set and a III-type electrode set, wherein different electrode structures will form different electric fields in vacuum gap. Paschen's curves for each electrode set under different electrode gaps, which are about breakdown voltage versus product of vacuum level and electrode gap, can be obtained through experiments. When the vacuum interrupter is in a high-vacuum or high-pressure environment, the electrode gap breakdown voltage needs to be higher under the same conditions, and the specific circumstances of the current vacuum level cannot be determined by relying only on the experimental curve of a single electrode and whether breakdown occurs or not. When multiple sets of electrodes with differentiated curves are combined to form the composite breakdown path breakdown electrode structure, it is possible to distinguish between the current vacuum level in a high-vacuum environment or high-pressure environment through different breakdown situations of different electrode set. When an applied voltage is U_{b} and a corresponding vacuum level is P₁, the I-type electrode set, the II-type electrode set and the III-type electrode set are broken down, broken down and unbroken, respectively. When an applied voltage is U_{b} and a corresponding vacuum level is P₂, the I-type electrode set, the II-type electrode set and the III-type electrode set are unbroken, unbroken and broken down, respectively. By judging the results of the composite electrode sets, the vacuum level or pressure range of the current vacuum interrupter can be determined.

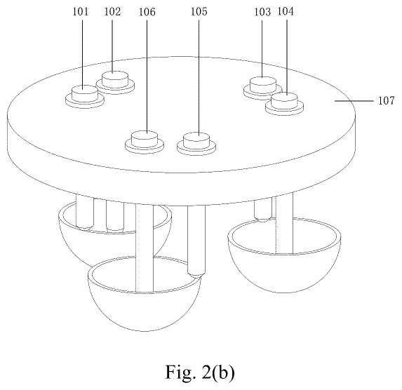

Referring to FIG. 2(a) and FIG. 2(b), the I-type electrode set of the composite breakdown path vacuum level detection electrode structure comprises a rod electrode 106 and a rod electrode collection electrode 105; the II-type electrode set comprises a needle electrode 102 and a needle electrode collection electrode 101; and the III-type electrode set comprises a ball electrode 104 and a ball electrode collection electrode 103. The three electrode sets are uniformly distributed on a ceramic insulating cover plate 107. The needle electrode collection electrode 101 is overall spoon-shaped, and a handle portion thereof is parallel to the needle electrode 102 and a spoon portion wraps an end portion of the needle electrode 102, so as to ensure an electron collecting effect. The ball electrode collection electrode 103 is overall spoon-shaped, and a handle portion thereof is parallel to the ball electrode 104 and a spoon portion wraps an end portion of the ball electrode 104, so as to ensure the electron collecting effect. The rod electrode collection electrode 105 is overall spoon-shaped, and a handle portion thereof is parallel to the rod electrode 106 and a spoon portion wraps an end portion of the rod electrode 106, so as to ensure the electron collecting effect.

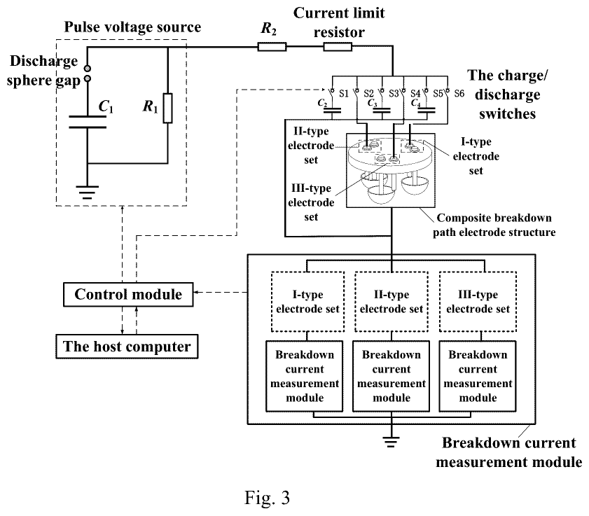

Referring to FIG. 3, a pulse voltage source first charges parallel capacitors C2, C3, and C4 of a charge/discharge switch set, at which time the charge/discharge switches S1, S2, and S3 are turned off and the other switches are turned on until the charging of the capacitors is saturated; then S1 and S2 are turned off and the other switches are turned on for II-type electrode set breakdown test; S3 and S4 are turned off and the other switches are turned on for III-type electrode set breakdown test; and S5 and S6 are turned off and the other switches are turned on for I-type electrode set breakdown test. Positive poles of the discharge capacitors are connected to collection electrodes of the I-type electrode set, the II-type electrode set and the III-type electrode set, while emitters, namely a I-type electrode, a II-type electrode and a III-type electrode, are grounded. A breakdown current measurement module is independent, and measurement results are returned to a control module each time. The control module communicates with a host computer, and the host computer sends commands to the control module so as to control a next pulse of the pulse voltage source or switching actions of the charge/discharge switch set.

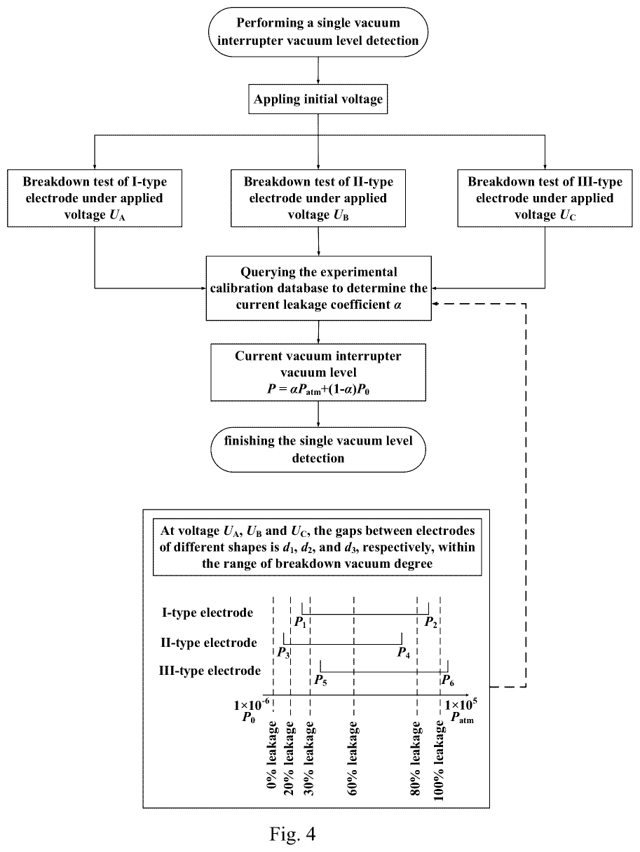

Referring to FIG. 4, the method comprises steps of: performing a single vacuum interrupter vacuum level detection, and setting up multiple independent composite breakdown path vacuum level detection electrode structures in a vacuum interrupter, wherein standard pulse voltages are independently applied on a I-type electrode set, a II-type electrode set and a III-type electrode set using independent breakdown measurement circuits; the three sets of electrodes adopts different gaps and independently applied voltages to avoid breakdown interference; the voltages applied to the three sets of electrodes are U_{A}, U_{B} and U_{C}, which are equal or different; wherein the three sets of electrodes are located under a vacuum environment inside the vacuum interrupter; obtaining breakdown conditions of the composite breakdown path vacuum level detection electrode structures by monitoring breakdown currents through the breakdown measurement circuits, and judging simultaneously whether breakdown occurs in the I-type electrode set, the II-type electrode set or the III-type electrode set; wherein if a breakdown current I_{bA} obtained by a breakdown measurement circuit of the I-type electrode set is greater than a preset breakdown current I_{b1} thereof, then the I-type electrode set is broken down:

$${I}_{bA} > {I}_{b 1} \qquad ( 1 )$$

otherwise, the I-type electrode set is unbroken; wherein if a breakdown current I_{bB} obtained by a breakdown measurement circuit of the II-type electrode set is greater than a preset breakdown current I_{b2} thereof, then the II-type electrode set is broken down:

$${I}_{bB} > {I}_{b 2} \qquad ( 2 )$$

otherwise, the II-type electrode set is unbroken; wherein if a breakdown current I_{bC} obtained by a breakdown measurement circuit of the III-type electrode set is greater than a preset breakdown current I_{b3} thereof, then the III-type electrode set is broken down:

$${I}_{bC} > {I}_{b 3} \qquad ( 1 )$$

otherwise, the III-type electrode set is unbroken; based on experimentally calibrated breakdown vacuum range of the three sets of electrodes under the different gaps, determining a current vacuum interrupter leakage situation and a leakage coefficient α according to the breakdown results of different electrode structure gaps under the different breakdown paths; to facilitate standard unification, taking an eigenvalue of a current determined vacuum range as a current leakage rate and the leakage coefficient; wherein if no breakdown occurs after applying the voltages U_{A}, U_{B} and U_{C} to the I-type electrode set, the II-type electrode set or the III-type electrode set, a vacuum level of the vacuum interrupter is normal and the leakage coefficient α=0; wherein if only the II-type electrode set is broken down, the vacuum interrupter suffers a 20% leakage and the leakage coefficient α=0.2; wherein if both the I-type electrode set and the II-type electrode set are broken down and the III-type electrode set is unbroken, the vacuum interrupter suffers a 30% leakage and the leakage coefficient α=0.3; wherein if all the three sets of electrodes are broken down, the vacuum interrupter suffers a 60% leakage and the leakage coefficient α=0.6; wherein if both the I-type electrode set and the III-type electrode set are broken down and the II-type electrode set is unbroken, the vacuum interrupter suffers a 80% leakage and the leakage coefficient α=0.8; wherein if only the III-type electrode set is broken down, the vacuum interrupter suffers a complete leakage and the leakage coefficient α=1; and according to the breakdown results of the different electrode structures and the different gaps in the different breakdown paths under the different voltages and same vacuum and air pressure conditions, obtaining the current vacuum interrupter leakage coefficient, and then calculating a current vacuum interrupter vacuum level P with an equation (4):

$$P = α {P}_{atm} + ( 1 - α ) {P}_{0} \qquad ( 4 )$$

wherein P₀=1×10⁻⁶ is a factory vacuum level of the vacuum interrupter, and Pₐₜₘ=1×10⁵ is atmospheric pressure; based on a combination of composite breakdown path breakdown situations, completing vacuum level detection, thereby finishing the single vacuum level detection.

The present invention is not limited to the above preferred embodiment. Those skilled in the art may make modifications and variations to the method for detecting the breakdown vacuum level of the composite breakdown path in accordance with the teachings of the present invention. All such modifications and variations shall fall within the scope of protection of the present invention.

What is claimed is:

1. A method for detecting breakdown vacuum level of a composite breakdown path, comprising steps of: based on a fact that different electrode shapes provide different electric field strengths, designing the composite breakdown path according to breakdown voltage characteristic differences of different breakdown paths; and based on breakdown results of different electrode structures in the different breakdown paths, performing vacuum interrupter vacuum level measurement and calibration;
wherein the method comprises specific steps of:
step 1: performing a single vacuum interrupter vacuum level detection, and setting up multiple independent composite breakdown path vacuum level detection electrode structures in a vacuum interrupter, wherein standard pulse voltages are independently applied on a I-type electrode set, a II-type electrode set and a III-type electrode set using independent breakdown measurement circuits; the three sets of electrodes adopts different gaps and independently applied voltages to avoid breakdown interference; the voltages applied to the three sets of electrodes are U_{A}, U_{B} and U_{C}, which are equal or different;
wherein the three sets of electrodes are located under a vacuum environment inside the vacuum interrupter;
step 2: obtaining breakdown conditions of the composite breakdown path vacuum level detection electrode structures by monitoring breakdown currents through the breakdown measurement circuits, and judging simultaneously whether breakdown occurs in the I-type electrode set, the II-type electrode set or the III-type electrode set; wherein if a breakdown current I_{bA} obtained by a breakdown measurement circuit of the I-type electrode set is greater than a preset breakdown current I_{b1} thereof, then the I-type electrode set is broken down:
$${I}_{bA} > {I}_{b 1} \qquad ( 1 )$$
otherwise, the I-type electrode set is unbroken;
wherein if a breakdown current I_{bB} obtained by a breakdown measurement circuit of the II-type electrode set is greater than a preset breakdown current I_{b2} thereof, then the II-type electrode set is broken down:
$${I}_{bB} > {I}_{b 2} \qquad ( 2 )$$
otherwise, the II-type electrode set is unbroken;
wherein if a breakdown current I_{bC} obtained by a breakdown measurement circuit of the III-type electrode set is greater than a preset breakdown current I_{b3} thereof, then the III-type electrode set is broken down:
$${I}_{bC} > {I}_{b 3} \qquad ( 3 )$$
otherwise, the III-type electrode set is unbroken;
step 3: based on experimentally calibrated breakdown vacuum range of the three sets of electrodes under the different gaps, determining a current vacuum interrupter leakage situation and a leakage coefficient α according to the breakdown results of different electrode structure gaps under the different breakdown paths; to facilitate standard unification, taking an eigenvalue of a current determined vacuum range as a current leakage rate and the leakage coefficient;
wherein if no breakdown occurs after applying the voltages U_{A}, U_{B} and U_{C} to the I-type electrode set, the II-type electrode set or the III-type electrode set, a vacuum level of the vacuum interrupter is normal and the leakage coefficient α=0;
wherein if only the II-type electrode set is broken down, the vacuum interrupter suffers a 20% leakage and the leakage coefficient α=0.2;
wherein if both the I-type electrode set and the II-type electrode set are broken down and the III-type electrode set is unbroken, the vacuum interrupter suffers a 30% leakage and the leakage coefficient α=0.3;
wherein if all the three sets of electrodes are broken down, the vacuum interrupter suffers a 60% leakage and the leakage coefficient α=0.6;
wherein if both the I-type electrode set and the III-type electrode set are broken down and the II-type electrode set is unbroken, the vacuum interrupter suffers a 80% leakage and the leakage coefficient α=0.8;
wherein if only the III-type electrode set is broken down, the vacuum interrupter suffers a complete leakage and the leakage coefficient α=1; and
step 4: according to the breakdown results of the different electrode structures and the different gaps in the different breakdown paths under the different voltages and same vacuum and air pressure conditions, obtaining the current vacuum interrupter leakage coefficient, and then calculating a current vacuum interrupter vacuum level P with an equation (4):
$$P = α {P}_{atm} + ( 1 - α ) {P}_{0} \qquad ( 4 )$$
wherein P₀ is a factory vacuum level of the vacuum interrupter, and Pₐₜₘ is atmospheric pressure;
based on a combination of composite breakdown path breakdown situations, completing vacuum level detection, thereby finishing the single vacuum level detection.

2. The method, as recited in claim 1, wherein a device for performing the method comprises a pulse voltage source, a charge/discharge switch set, the composite breakdown path vacuum level detection electrode structure, a breakdown current measurement module, a control module, and a host computer; wherein through the separate actions of the charge/discharge switch set, the independent voltages are applied on the I-type electrode set, the II-type electrode set and the III-type electrode set; the breakdown current measurement module is independent, and measurement results are returned to the control module each time; the control module communicates with the host computer, and the host computer sends commands to the control module so as to control a next pulse of the pulse voltage source or a switching action of the charge/discharge switch set.

3. The method, as recited in claim 1, wherein the I-type electrode set, the II-type electrode set and the III-type electrode set are rod electrode set, needle electrode set and ball electrode set, respectively; or composite ring electrode sets and plate electrode sets with obvious breakdown differences.

4. The method, as recited in claim 3, wherein the needle electrode set comprises a needle electrode (102) and a needle electrode collection electrode (101); wherein the needle electrode collection electrode (101) is overall spoon-shaped, and a handle portion thereof is parallel to the needle electrode (102) and a spoon portion wraps an end portion of the needle electrode (102), so as to ensure an electron collecting effect; the ball electrode set comprises a ball electrode (104) and a ball electrode collection electrode (103); wherein the ball electrode collection electrode (103) is overall spoon-shaped, and a handle portion thereof is parallel to the ball electrode (104) and a spoon portion wraps an end portion of the ball electrode (104), so as to ensure the electron collecting effect; the rod electrode set comprises a rod electrode (106) and a rod electrode collection electrode (105); wherein the rod electrode collection electrode (105) is overall spoon-shaped, and a handle portion thereof is parallel to the rod electrode (106) and a spoon portion wraps an end portion of the rod electrode (106), so as to ensure the electron collecting effect.

5. The method, as recited in claim 3, wherein materials of the rod electrode set, the needle electrode set and the ball electrode set are selected from a group consisting of Cu, CuCr, Fe, W and Al.

6. The method, as recited in claim 1, wherein the standard pulse voltages are high-frequency pulse voltages.

7. The method, as recited in claim 1, wherein the single vacuum level detection is performed periodically; between multiple detections, it is necessary to wait for metal vapors to be deposited on a collection hood before detecting again; and an interval period is assigned by days, weeks or months.

8. The method, as recited in claim 1, wherein the multiple independent composite breakdown path vacuum level detection electrode structures are mounted on a static end cover plate or a movable end cover plate of the vacuum interrupter.
